(19) United States
(12) Patent Application Publication
(10) Pub. No.: US 2005/0120074 A1
(43) Pub. Date: Jun. 2, 2005

(54) Method for display of multimedia content

(76) Inventor: Nandan Vinayakrao Kundetkar, Singapore (SG)

Correspondence Address: Stephen M De Klerk;Blakely Sokoloff Taylor & Zafman, Seventh Floor, 12400 Wilshire Boulevard, Los Angeles, CA, 90025, US

(21) Appl. No.: 10/499,080

(22) PCT Filed: Dec. 14, 2002
(86) PCT No.: PCT/SG02/00291

(30) Foreign Application Priority Data
Dec. 14, 2001 (SG) 01079177

(51) Int. Cl. G06F 15/16

(52) U.S. Cl. 709/203

(57) ABSTRACT

A method for display of multimedia content in real time including the steps of determining a MIME type in which the content is formatted; if the content is in a first format, allowing streaming of the content for display using an application capable of displaying multimedia content; if the content is in a second format, parsing the content, and retrieving a list of URLs for all files for the content, accessing the URLs to obtain a datastream of the content; and piping the datastream for display using the application.

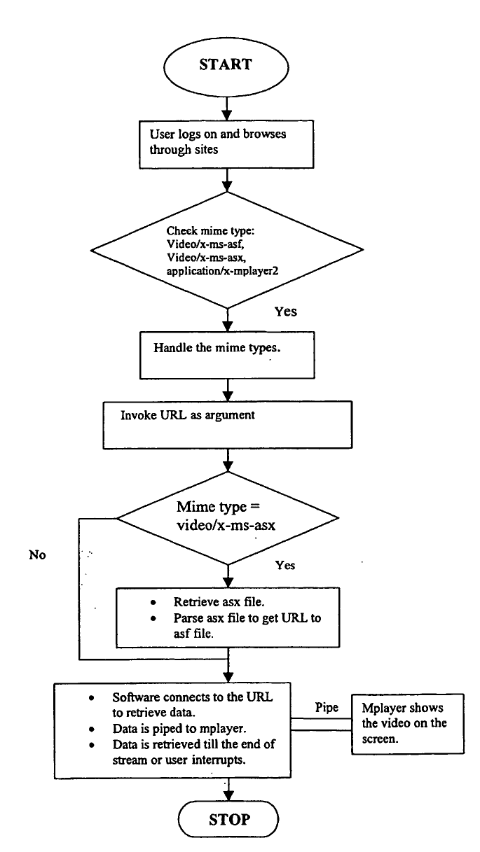

### FIELD OF THE INVENTION

This invention relates to a method for display of multimedia content over a network, in real time, and refers particularly, though not exclusively, to a method for display of multimedia content obtained over a network, on a user's machine, where the content can be displayed by a single application even though the content is not intended to be displayed using that application.

### DEFINITIONS

Throughout this specification a reference to a network is to include all forms of telecommunications networks including those over cable, fibre optic cables, wireless, satellites, and direct broadcast (as in television and radio). This includes local area networks, wide area networks, the Internet, and the World Wide Web.

Throughout this specification a reference to real time is to be taken as allowing for any delays due to delays in transmission which can be incurred due to problems in the network such as, for example, bandwidth; any delays due to processing time taken (usually in the order of seconds); and any delays due to system buffers to accommodate the streaming. It does not include, and specifically excludes, systems where the streamed data is saved to a disk or other permanent storage medium for subsequent display.

### BACKGROUND TO THE INVENTION

There has been considerable expansion in the availability of multimedia content over the Internet. Even full-length motion pictures can be downloaded for viewing in real time using streaming media systems. Unfortunately, much of this content is platform-specific so that a user must have the required application to view and/or hear the content. This causes significant problems for users in that they must purchase a number of applications they might otherwise not require solely to view certain on-line content.

It is therefore the principal object of the present invention to provide a method for display of multimedia content in real time that will enable the content to be displayed even if the content is on a platform that is not compatible with that of the user.

### SUMMARY OF THE INVENTION

With the above and other objects in mind, the present invention provides a method for display in real time of multimedia content including the steps of:
(a) determining a multipurpose Internet mail extension type in which a content is formatted;
(b) if the content is in a first format allowing streaming the content for display using an application capable of displaying multimedia content;
(c) if the content is in a second format, parsing the content, and retrieving a list of universal resource locators for all files for the content;
(d) accessing the universal resource locators to obtain a datastream of the content; and
(e) piping the datastream for display using the application.

The first format may be an open source format, and the application may be an open source application such as, for example, Mplayer. The second format may be active streaming format.

The obtaining of the datastream may be by use of a protocol, and the protocol may be hypertext transfer protocol or multimedia server.

The parsing of the content may be of the asx file containing the URLs of the files of the content.

### DESCRIPTION OF THE DRAWINGS

In order that the invention may be fully understood and readily put into practical effect, there shall now be described by way of non-limitative example only a preferred embodiment of the present invention, the description being with reference to the accompanying illustrative drawing which is a flow chart of the operation of the system of the present invention.

### DESCRIPTION OF PREFERRED EMBODIMENT

To refer to the drawing, upon a user starting 10 and logging in 12 they browse through various web sites having multimedia content. Upon selecting a web site 14, the system (which is on the user's machine) must first determine the MIME (Multipurpose Internet Mail Extensions) type of the content the user has selected. For example, the content may be one of:
active streaming format-video/x-ms-asf; or
an open source application such as Mplayer-application/x-mplayer-2.

The asf files may have their URLs contained within an asx file-wvideo/x-ms-asx;

If the URLs are in the asx file, the system parses the asx file to obtain the URLs of all the asf files in which the content is held. Those URLs are then accessed in the correct order (as determined from the asx file) and the datastream is retrieved using http or mms protocols. The datastream is then piped and invoked in an open source application such as, for example, Mplayer. The datastream can then be displayed on the user's machine using Mplayer (or an equivalent) despite having been held in asf format.

Files held in other media formats such as, for example, MPEG-1, MPEG-2, DivX, and so forth proceed without change.

The data is retrieved until the end of the stream or until the user interrupts the display. The data files retrieved are displayed using Mplayer.

As mplayer is the most widely used video player for the * nix platform, it has support for emulating windows-like interfaces to interact with binary codecs (coders/decoders). This makes the task of including newer codecs far more simple. It can support avi, mpeg and asf file formats. However, current versions of Mplayer can only play pre-recorded files or http-based stream content and not a broadcasted stream.

Whilst there has been described in the foregoing description a preferred embodiment of the present invention, it will be understood by those skilled in the technology that many variations or modifications in details of operation may be made without departing from the present invention as defined in the appended claims.

1. A method for display in real time of multimedia content including the steps of:
(a) determining a multipurpose Internet mail extension type in which the content is formatted;
(b) if the content is in a first format, allowing the streaming of the content for display using an application capable of displaying multimedia content;
(c) if the content is in a second format, parsing the content, and retrieving a list of universal resource locators for all files for the content;
(d) accessing the universal resource locators to obtain a datastream of the content; and
(e) piping the datastream for display using the application.

2. A method as claimed in claim 1, wherein the first format is an open source format.

3. A method as claimed in claim 2, wherein the application is an open source application.

4. A method as claimed in claim 3, wherein the application is Mplayer.

5. A method as claimed in claim 1, wherein the second format is active streaming format.

6. A method as claimed in claim 1, wherein the obtaining of the datastream is by use of a protocol.

7. A method as claimed in claim 6, wherein the protocol is hypertext transfer protocol.

8. A method as claimed in claim 6, wherein the protocol is multimedia server.

9. A method as claimed in claim 1, wherein the parsing of the content is of an asx file containing the universal resource locators.
